(19) United States
(12) Patent Application Publication
(10) Pub. No.: US 2016/0339584 A1
(43) Pub. Date: Nov. 24, 2016

(54) ROBOT FOR INSPECTION OF CONFINED SPACES

(71) Applicant: Airbus Defence and Space S.A., Getafe (ES)

(72) Inventors: Fernando Enrique ESTEBAN FINCK, Getafe (ES); Francisco José LEÓN ARÉVALO, Getafe (ES); Antonio GIRÓN CRUZ, Getafe (ES); Francisco Javier SÁNCHEZ RIVAS, Getafe (ES); Lucas GIRELA BAENA, Getafe (ES)

(21) Appl. No.: 15/154,427

(22) Filed: May 13, 2016

(30) Foreign Application Priority Data
May 20, 2015 (EP) 15382263.0

(51) Int. Cl. B25J 9/06; B25J 19/02

(52) U.S. Cl. CPC B25J 9/065; B25J 19/023; Y10S 901/47; Y10S 901/44; Y10S 901/15; Y10S 901/23; Y10S 901/25; F16L 2101/30

(57) ABSTRACT

The disclosure herein provides a robot for inspecting confined space comprising a robotic arm, an end-effector provided with inspection equipment and a control system. The robotic arm is formed by a fixed base and first and second modules respectively formed by first and second links connected by first and second articulations that are configured such that the maximum opening angles α and β of their first and second articulations are, respectively, ±30° and ±55°. The first links are driven by tendons attached to them by one of their ends and to first actuating devices located at the fixed base by the other end. The second links are driven by second actuating devices located on the second links. The different configuration of the first and second module of the robot arm allows access to confined spaces in environments with obstacles.

### CROSS-REFERENCE TO RELATED APPLICATION

This application claims the benefit of and priority to European patent application No. 15382263.0 filed on May 20, 2015, the entire disclosure of which is incorporated by reference herein.

### TECHNICAL FIELD

The present disclosure relates to a robot for inspecting confined spaces in, particularly, aeronautical structures.

### BACKGROUND

In the aeronautic industry the occurrence of dry leaks in tanks and pipes is very common that are sometimes difficult to detect because they occur in narrow confined spaces where is not easy to implement detection techniques based on helium, bubbles or a specific trace gas.

Another problem is the difficulty of detecting obstructions inside pipes.

To solve such problems in, particularly, pipes the use of snake-type robots provided with an end-effector having suitable inspection equipment such as that described, for example, in U.S. Pat. No. 7,171,279 has been proposed.

However, these robots do not meet all the conditions required for accessing to the interior of aeronautical structures where the end-effector must move in narrow spaces of difficult access and having obstacles to be overcome.

The present disclosure is directed to solving that problem.

### SUMMARY

The disclosure herein provides a robot for inspecting confined spaces comprising a robotic arm, an end-effector provided with inspection equipment and a control system. The robotic arm is formed by a fixed base and first and second modules respectively formed by first and second links connected by first and second articulations that are configured such that the maximum opening angles α γ β of their first and second articulations are, respectively, ±30° and ±55°. The first links are driven by tendons attached to them by one of their ends and to first actuating devices located at the fixed base by the other end. The second links are driven by second actuating devices located on the second links. The different configuration of the first and second module of the robot arm allows access to confined spaces in environments with obstacles.

In one embodiment the end-effector is formed by a third link, attached to the last second link by a second articulation and by a final link, carrying inspection equipment (in particular a vision camera and an IR camera) connected to the third link by a pitch axis. Thus the inspection equipment can be placed in the desired location making pitch and roll movements relative to the last second link.

In one embodiment, the first links of the first module are driven by three tendons and the first articulations are Cardan joints.

In one embodiment, the second articulations of the second links of the second module are Cardan joints whose cross shaft comprises two toothed wheels associated with its two axes and the second actuating devices comprise a motor-reduction gear assembly having a cooperating final pinion with the toothed wheels.

Other desirable features and advantages of this disclosure herein will become apparent from the subsequent detailed description of the disclosure herein and the appended claims, in relation with the enclosed drawings.

### BRIEF DESCRIPTION OF THE DRAWINGS

FIG. 1 is a schematic cross sectional view illustrating a robot according to the disclosure herein formed by a first and a second module, with five links each, in its resting state.

FIG. 2 is a schematic view of the robot of FIG. 1 in an operating state illustrating the different mobility of the links of its two modules.

FIG. 3 is a schematic view of the drive of the first links of the first module.

FIG. 4 is a schematic view of the drive of the second links of the second module.

FIGS. 5a and 5b are top and bottom views of a second link showing the configuration of its two articulations and the engagement between an articulation of a second link and the final pinion of a motor disposed inside the second link.

FIG. 6 is a schematic view of the structure and drive of the end-effector.

FIG. 7 is a perspective view of the end-effector.

FIG. 8 is a perspective view of the structure allowing the pitching movement of the end-effector.

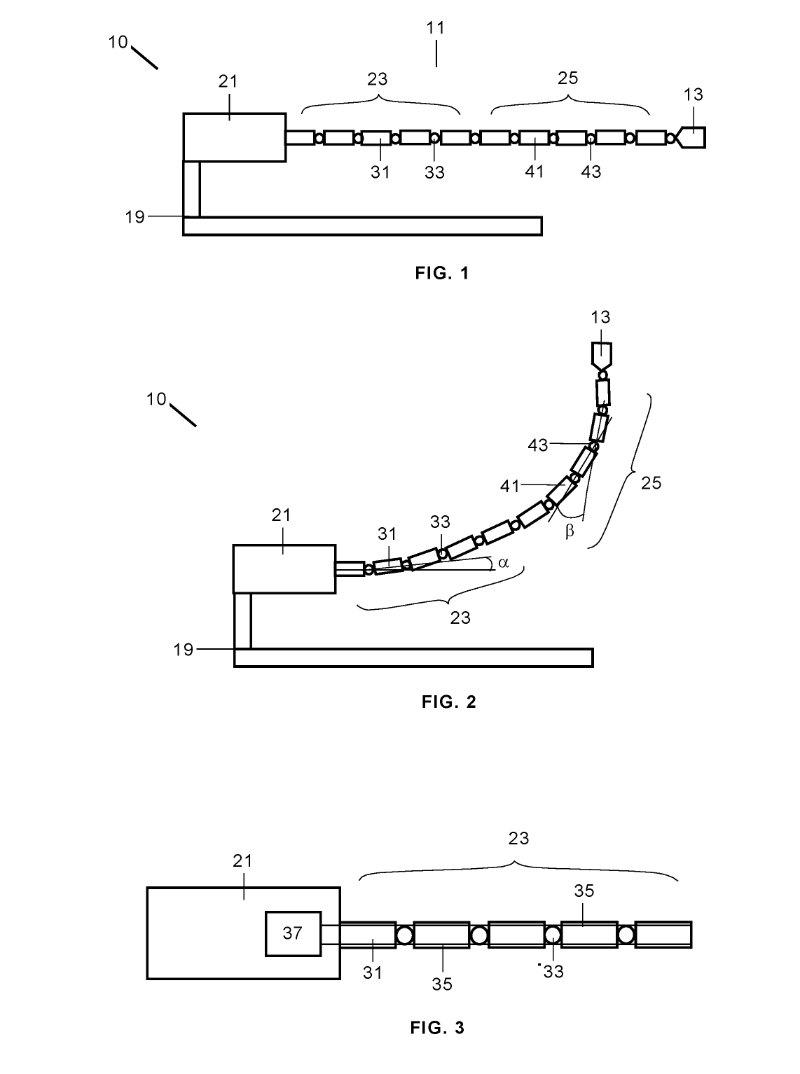

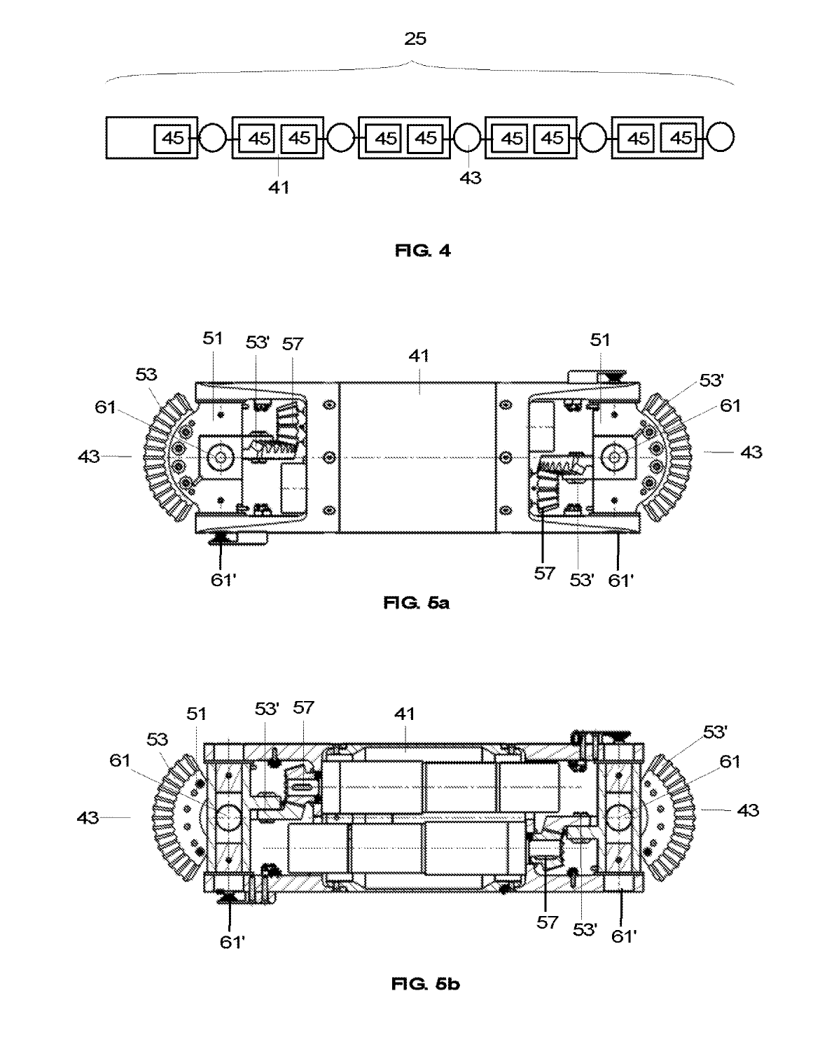

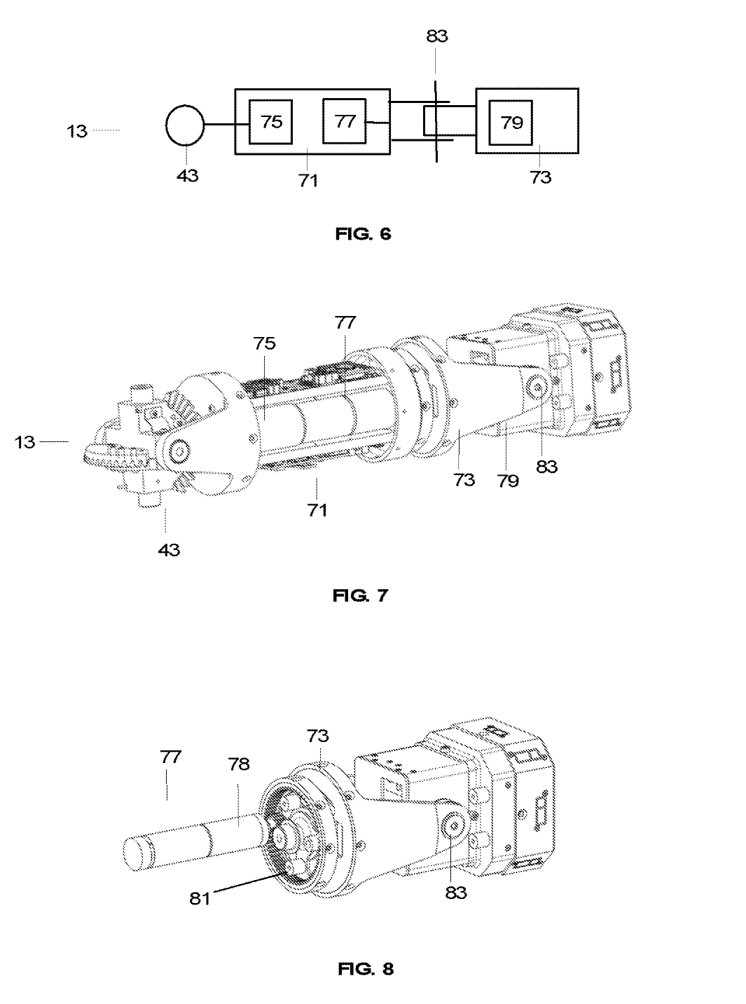

### DETAILED DESCRIPTION

A description of a robot 10 according to the disclosure herein intended, particularly, to the inspection of aircraft confined spaces such as a fuel tank follows.

The robot 10 comprises:
A robotic arm 11 and an end-effector 13, the first being configured to position the second within a confined space in precise locations to inspect it, the second having the equipment or structure needed to carry out inspection tasks such as a vision camera and an IR camera.
A control, power and interface system formed by any suitable structure or means for controlling and supplying power to the components of the robotic arm 11 and the end-effector 13.
A user interface allowing an operator to interact with the robot 10 and control it.
A support structure 19 that can also have displacement mechanism or means.

The robotic arm 11 is formed by a fixed base 21, a first module 23 (that will be also called tendons module) and a second module 25 (that will be also called motorized module).

The tendons module 23 is formed, in a manner known in the art, by first links 31, connected by first articulations 33 configured particularly as Cardan joints, which are driven by tendons 35 (for example, by three tendons for each first link 31 if they must have 3 degrees of freedom) that are attached at its other end to first actuating devices 37 (one for each tendon 35) located on the fixed base 21.

The motorized module 25 is formed by second links 41, connected by second articulations 43, which are driven by second actuating devices 45 located on the second links 41.

The robotic arm 11 therefore comprises first and second links 31, 41 capable of performing three-dimensional movements, allowing placing the end-effector 13 anywhere in the work space thanks to the different configurations that the first and second links 31, 41 can achieve.

The two mentioned modules differ both in the mobility technique implemented by them and in the load and angles capacities that they can achieve. The tendons module 23 is configured to support a given weight threshold (for example 20 kg) and to have a maximum opening angle of ±30° in their first articulations 33. The motorized module 25 is configured to support less weight but to have a maximum opening angle of ±55° on their second articulations 43. On the other hand, the end-effector 13, located after the motorized module 25, contains the necessary sensors for the inspection tasks.

The fixed base 21 is the bulkiest part of the robot. Its function is to provide physical support to the robotic arm 11 and host the first actuating devices 37 of the first links 31 of the tendons module 23 which occupy a considerable space that makes impossible to integrate them within it.

Such first actuating devices 37 are, preferably, ball screws driven by motors to pull the tendons 35 acting on the first links 31 and brakes to maintain the first links 31 on a certain position and to prevent unwanted movements due to the weight of the system. They also comprise equipment or structure associated to the control system of the robot such as, particularly, an encoder for each motor to measure the number of rotations thereof during displacement of the nut along the spindle and to know therefore the movement produced in the first articulations 33 of the tendons module 23 and a limit switch per spindle to delimit the displacement of the tendons 35 within the limits fixed for each first articulations 33. There are no sensors therefore in the first articulations 33 to verify the accuracy of the axis rotations due to both the precision of the encoders associated to the motors and the low elongation of the tendons 35 if wires with an appropriate strength are chosen.

In the case of the second links 41, the second actuating devices 45 that generate their movements are located inside them. This characteristic, together with the design of the second articulations 43, allows the robotic arm 11 to achieve more complex and inclined positions during its movement.

The second articulations 43 are Cardan joints whose cross shaft includes two toothed wheels associated to their shafts 61, 61′.

The second actuating devices 45 comprise a motor-reduction gear assembly with and geared motor assembly with a final pinion 57 in the output axis which meshes toothed wheels 53, 53′ of the cross shaft 51.

To measure the rotation angle produced on the shafts 61, 61′ of a second articulation 43 one absolute rotary encoder of magnetic type mounted in the own articulation for each one of axes 61, 61′ is used. It is mainly formed by two components: a Hall-effect sensor integrated in the circuit and a field magnet. Its operating principle is based on the magnetic activity detected in the sensor due to the variation of its orientation relative to the magnet.

The second actuating devices 45 also comprise a brake to ensure immobilization of the robotic arm 11 in a given configuration.

The end-effector 13 is formed by a third link 71 connected to the last second link 41 of the motorized module 25 by a second articulation 43 and a final link 73, attached to the third link 71 by a pitch axis 83, which houses the components necessary for the inspection function.

The final link 73 may comprise a quick connect/disconnect connector, which collect in their pins the electrical signals of all the inspection devices so that it can operate without being connected directly to the robotic arm 11. Thus, an operator can use the inspection devices located in the end-effector 13, regardless of the robot 10.

Navigation sensors, inspection sensors and various points of artificial light are included among the components of the final link 73 of the inspection end-effector 13.

As navigation sensors the final link 73 comprises an encoder at the exit of its rotation axis for correction and feedback of the motion made and a distance sensor to know the minimum safe distance to allow the robotic system to move without risk of collision with obstacles and boundaries of the environment. In the case of the aeronautical structures to which the robot is intended it can be assumed that the safe distance is in the 10-14 cm range.

As inspection sensors the final link 73 comprises a vision camera and an IRT (“Infra-Red Thermography”) camera. The view camera should preferably meet the following functional requirements: autofocus, digital zoom, high resolution, adaptation to changes in lighting, compact size and light weight. The IRT camera allows a thermographic inspection which is considered the most appropriate for obstructions inside ducts of aeronautical structures.

The third link 71 comprises on one side an actuating device 75, similar to the second actuating devices 45 of the second module 25, cooperating with a toothed wheel 53 of the last second articulation 43. On the other side comprises a third actuating device 77 such as a motor with an output pinion 78 cooperating with a ring gear 81 to produce a rolling movement to the end-effector 13.

The final link 73 comprises a fourth actuating device 79 which is arranged to transmit it a pitching movement rotating it over the pitch axis 83 through a suitable transmission system.

Although the present disclosure has been described in connection with various embodiments, it will be appreciated from the specification that various combinations of elements, variations or improvements therein may be made, and are within the scope of the disclosure herein as defined by the appended claims.

While at least one exemplary embodiment of the invention(s) herein is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A robot for inspecting confined spaces comprising a robotic arm, an end-effector comprising inspection equipment and a control system, the robotic arm comprising a fixed base and a first module adjacent to the fixed base formed by several first links connected by first articulations; the first links being driven by tendons attached to them by one end and to first actuating devices located at the fixed base by the other end;
wherein:
the first module is configured so that the maximum opening angle α in the first articulations is ±30°;
and further comprising a second module arranged next to the first module that comprises several second links, connected by second articulations, which are driven by second actuating devices located in the second links, the second module being configured so that the maximum opening angle β in the second articulations is ±55°.

2. The robot according to claim 1, wherein the end-effector is arranged next to the second module so that the inspection equipment can perform pitching and rolling movements relative to the last second link.

3. The robot according to claim 2, wherein the end-effector is formed by a third link, attached to the last second link by a second articulation, and a final link, carrying the inspection equipment , connected to the third link by a pitch axis.

4. The robot according to claim 3, wherein the third link comprises a third actuating device cooperating with a ring gear disposed adjacent to the final link to perform the rolling movements of the end-effector.

5. The robot according to claim 3, wherein the final link comprises a fourth actuating device cooperating with the pitch axis to perform the pitching movements of the final link.

6. The robot according to claim 1, wherein the inspection equipment arranged in the end-effector comprises at least one vision camera and one IRT camera.

7. The robot according to claim 1, wherein each first link is driven by three tendons and the first articulations are Cardan joints.

8. The robot according to claim 1, wherein the second articulations are Cardan joints whose cross shaft comprises two toothed wheels associated with their shafts and the second actuating devices comprise a motor-reduction gear assembly with a final pinion cooperating with the toothed wheels.

9. The robot according to claim 8, wherein the second actuating devices also comprise a brake.
